(19) United States
(12) Patent Application Publication
(10) Pub. No.: US 2009/0283381 A1
(43) Pub. Date: Nov. 19, 2009

(54) SLIDING CLUTCH IN A TRANSMISSION

(75) Inventor: James A. Raszkowski, Indianapolis, IN (US)

Correspondence Address: VIVACQUA LAW, PLLC, 455 East Eisenhower Parkway, Suite 11, ANN ARBOR, MI, 48108, US

(73) Assignee: GM GLOBAL TECHNOLOGY OPERATIONS, INC., Detroit, MI (US)

(21) Appl. No.: 12/413,282

(22) Filed: Mar. 27, 2009

Related U.S. Application Data
(60) Provisional application No. 61/053,236, filed on May 15, 2008.

(51) Int. Cl. F16D 11/10; F16H 63/30

(52) U.S. Cl. 192/69; 74/473.11

(57) ABSTRACT

A sliding clutch assembly for selectively rotatingly coupling a first shaft or member to a second shaft or member includes a piston housed within the first member. The piston is rotatingly coupled to the first member. The piston is moveable between two positions. In the first position, the piston does not engage the second member. In the second position, a feature on the piston engages a feature on the second member such that the piston is rotatingly coupled to both the first member and the second member.

### CROSS-REFERENCE TO RELATED APPLICATIONS

This application claims the benefit of U.S. Provisional Application No. 61/053,236, filed on May 15, 2008. The disclosure of the above application is incorporated herein by reference.

### FIELD

The invention relates generally to a sliding clutch in a transmission, and more particularly to a hydraulically actuated, splined sliding clutch operable to transmit torque in a transmission.

### BACKGROUND

The statements in this section merely provide background information related to the present disclosure and may or may not constitute prior art.

A dual countershaft automatic transmission with co-planar gear sets having single torque paths can offer, in some embodiments, efficiency and cost advantages over typical planetary gear set transmission designs. Dual countershaft transmissions typically have a plurality of multidisc rotating clutches which allow gear and/or shaft components to be selectively connected in order to provide the desired transmission gear speed or ratio with a full power shift. A dual countershaft transmission may include a multidisc clutch operable to connect an input shaft directly to an output shaft in order to provide a direct (1:1) ratio. The location of this multidisc clutch is limited by the transmission architecture and packaging, but generally may be located between the input shaft and the output shaft or at the rear of the transmission by adding an additional shaft through the center of the mainshaft.

However, locating the clutch between the input shaft and the output shaft adds length to the countershaft section which in turn requires the countershaft and mainshaft sizes to increase in order to provide sufficient stiffness and strength to support the gear loads. Placing the clutch at the rear reduces the shafts' length (and corresponding diameter size) but adds cost and complexity due to the added shaft needed to connect the clutch to the input. Additionally, this clutch location adds length in the output section. Accordingly, there is a need in the art for a torque transmitting device that reduces size, weight, cost, and complexity in a transmission but that is operable to effectively couple two rotating shafts together.

### SUMMARY

The present invention provides a sliding clutch assembly for selectively rotatingly coupling a first shaft or member to a second shaft or member. The sliding clutch assembly includes a piston housed within the first member. The piston is rotatingly coupled to the first member. The piston is moveable between two positions. In the first position, the piston does not engage the second member. In the second position, a feature on the piston engages a feature on the second member such that the piston is rotatingly coupled to both the first member and the second member.

In one aspect of the present invention, the sliding clutch assembly includes a biasing member that biases the piston to the first position.

In another aspect of the present invention, the piston is a sleeve supported by a third member.

In yet another aspect of the present invention, the piston is moved to the second position by a pressurized hydraulic fluid.

In yet another aspect of the present invention, the features on the piston and on the first and second members are splines.

Further objects, aspects and advantages of the present invention will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1A is a schematic cross section of a portion of a transmission assembly having a sliding clutch according to the principles of the present invention in a first position; and

FIG. 1B is a schematic cross section of a portion of a transmission assembly having a sliding clutch according to the principles of the present invention in a second position.

### DETAILED DESCRIPTION

The following description is merely exemplary in nature and is not intended to limit the present disclosure, application, or uses.

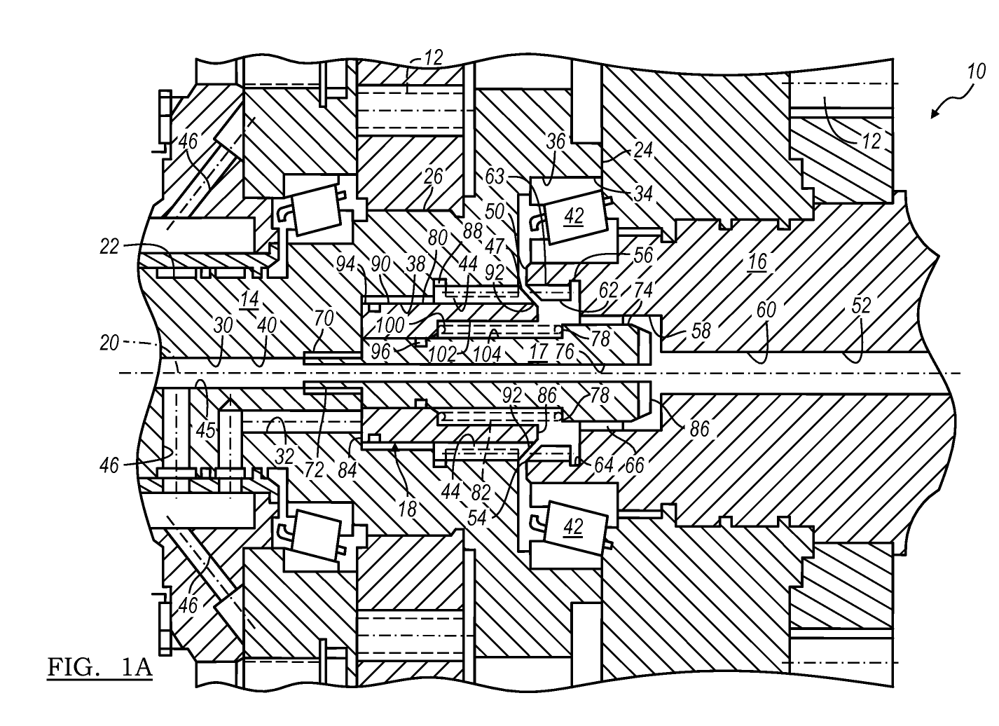

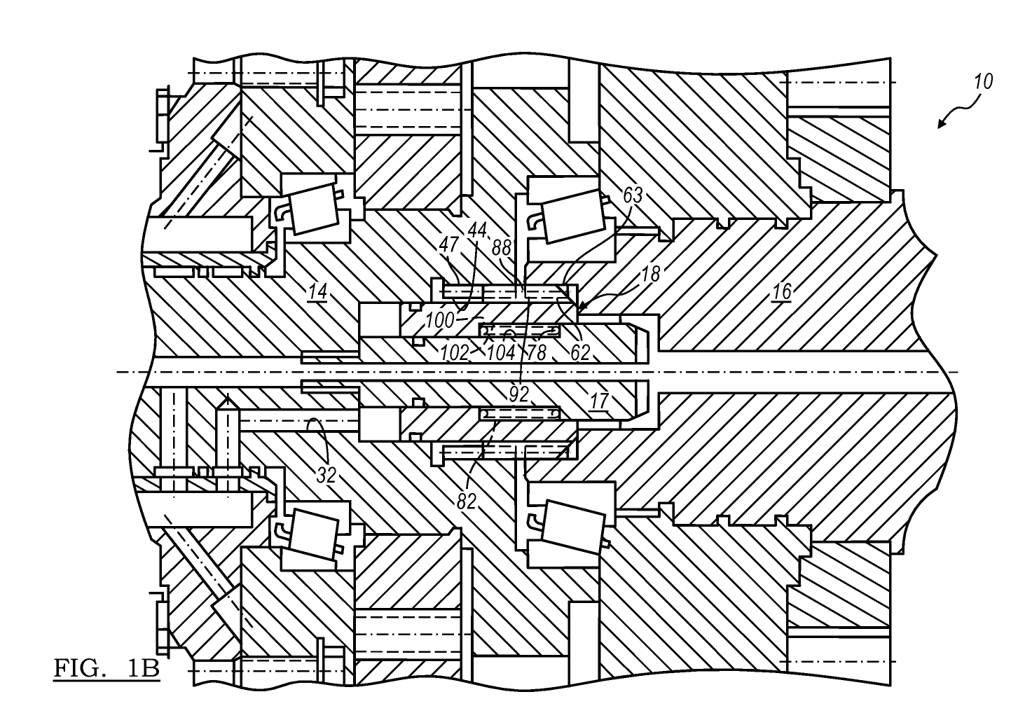

With reference to FIG. 1, a portion of an exemplary transmission assembly is generally indicated by reference number 10. The transmission 10 includes a plurality of gear sets 12, a first shaft or member 14, a second shaft or member 16, a third shaft or member 17, and a sliding clutch assembly 18. In the embodiment provided, the first member 14 is an input shaft that receives an input torque from a torque converter (not shown) connected to a prime mover (not shown), such as a combustion engine or electric motor, and the second member 16 is a main shaft or output shaft that transmits an output torque to a transfer case (not shown) or final drive unit (not shown). However, the first and second members 14, 16 may be various other shafts or members, such as countershafts or intermediate shafts, without departing from the scope of the present invention. The plurality of gear sets 12 cooperate with a plurality of torque transmitting devices (not shown) to transmit torque from the first member 14 to the second member 16 in a plurality of forward speed or torque ratios and at least one reverse speed or torque ratio. Each forward and reverse speed or torque ratio is attained by engagement of one or more of the torque-transmitting devices. In the embodiment provided, the gear sets 12 are co-planar gear sets that extend between the first and second members 14, 16 and countershafts (not shown), however, the gear sets may take various forms, such as planetary gear sets, without departing from the scope of the present invention.

The first member 14 is generally elongated and defines a longitudinal axis, indicated by reference number 20. The first member 14 includes a body portion 22 having a first end (not shown) that engages the torque converter and a second end 24 that is located longitudinally opposite the first end. The first member 14 further includes an enlarged portion 26 located near the second end 24 that has an outer diameter greater than an outer diameter of the body portion 22. The first member 14 is coupled to or intermeshed with a portion of the plurality of gear sets 12 along the length of the first member 14.

The first member 14 defines a central bore 30 and a clutch actuation bore 32. The central bore 30 is concentric along the axis 20 and extends from an opening 34 in the second end 24 through the end portion 26 and into the body portion 22. The central bore 30 includes three portions: a first portion 36 extending from the opening 34 into the end portion 26, a second portion 38 extending from the first portion 36 towards the body portion 22, and a third portion 40 extending from the second portion 38 along the longitudinal length of the body portion 22. The first portion 36 has an inner diameter greater than the inner diameters of the second portion 38 and the third portion 40, and the second portion 38 has an inner diameter greater than the inner diameter of the third portion 40. The first portion 36 is used to support a plurality of bearings 42 that in turn support the second member 16 and allow the second member 16 to rotate relative to the first member 14. The second portion 38 includes a splined portion 44 formed on an inner surface 45 of the central bore 30. The splined portion 44 includes a plurality of splines 47 that are operable to engage the sliding clutch assembly 18, as will be described in greater detail below. It should be appreciated that other engageable features other than splines may be employed without departing from the scope of the present invention. The third portion 40 connects with a plurality of fluid passages 46 and is operable to transmit hydraulic fluid from a hydraulic control system within the transmission along the length of the first member 14.

The actuation bore 32 connects with one of the plurality of fluid passages 46 and connects with the second portion 38 of the central bore 30. The actuation bore 32 is operable to deliver pressurized hydraulic fluid to the second portion 38 in order to hydraulically actuate the sliding clutch assembly 18, as will be described in greater detail below.

The second member 16 is also generally elongated and is concentric with the longitudinal axis 20. The second member 16 includes a first end (not shown) that engages a final drive unit or other output member and a second end 50 that is located longitudinally opposite the first end. The second member 16 is coupled to or intermeshed with a portion of the plurality of gear sets 12 along the length of the second member 16.

The second member 16 defines a central bore 52. The central bore 52 is concentric along the axis 20 and extends from an opening 54 in the second end 50 into and along the length of the second member 16. The central bore 52 includes three portions: a first portion 56 extending from the opening 50 into the second member 16, a second portion 58 extending from the first portion 56 towards the first end of the second member 16, and a third portion 60 extending from the second portion 58 along the longitudinal length of the second member 16. The first portion 56 has an inner diameter greater than the inner diameters of the second portion 58 and the third portion 60, and the second portion 58 has an inner diameter greater than the inner diameter of the third portion 60. The first portion 56 includes a splined portion 62 formed on an inner surface 64 of the central bore 52. The splined portion 62 includes a plurality of splines 63 that are operable to engage the sliding clutch assembly 18, as will be described in greater detail below. It should be appreciated that other engageable features other than splines, for example gear teeth or detents, may be employed without departing from the scope of the present invention. The second portion 58 is used to support a bushing 66 that in turn supports the third member 17 and allows the third member 17 to rotate relative to the second member 16. Finally, the third portion 40 is operable to transmit hydraulic fluid from the hydraulic control system within the transmission along the length of the second member 16.

The second member 16 is positioned within the transmission 10 such that the second member 16 is longitudinally aligned with the first member 14 and the second end 50 of the second member 16 is located within the first portion 36 of the first member 14. Moreover, the second end 50 is supported for rotation by the bearings 42 and the splined portion 62 of the second member 16 is aligned with the splined portion 44 of the first member 14.

The third member 17 is located between the first member 14 and the second member 16 within the central bores 30 and 52. More specifically, the third member 17 includes a splined end 70 that extends into the third portion 40 of the central bore 30. The splined end 70 engages or is intermeshed with a splined or toothed portion 72 located on the inner surface 45 of the central bore 30. Accordingly, the third member 17 is rotationally coupled to the first member 14. Again, it should be appreciated that features other than splines or gear teeth may be employed in the splined end 70 and splined portion 72 without departing from the scope of the present invention. The third member 17 further includes an end 74 located longitudinally opposite the splined end 70. The end 74 extends into the second portion 58 of the second member 16. The end 74 is supported by the bushing 66 which allows the third member 17 to rotate freely with respect to the second member 16. The third member 17 defines a central bore 76 that is concentric with the longitudinal axis 20. The central bore 76 allows for fluid communication between the central bore 30 of the first member 14 and the central bore 52 of the second member 16. Finally, the second member 17 includes a detent 78 located on an outer surface of the third member 17.

The sliding clutch assembly 18 is used to selectively rotatingly couple the first member 14 with the second member 16, as will be described in greater detail below, in order to allow torque to be transmitted between the first member 14 and the second member 16. The sliding clutch assembly 18 includes the third member 17 as well as a piston or sleeve shaft 80 and a biasing member 82. The piston 80 is slidingly supported on the third member 17 and is housed within the first member 14. The piston 80 is moveable between a first position, shown in FIG. 1A, and a second position, shown in FIG. 1B. The piston 80 includes a first end 84 and a second end 86 located longitudinally opposite the first end 84. The piston 80 also includes a splined portion 88 located on an outer surface 90 located near or proximate to the second end 86. The splined portion 88 is comprised of a plurality of splines 92 that extend out from the outer surface 90. The splined portion 88 is configured to intermesh or engage the splined portion 44 of the first member 14 and to selectively intermesh or engage the splined portion 62 of the second member 16. Accordingly, the splined portion 88 has a length sufficient to simultaneously engage both splined portions 44 and 62 when in the second position. It should be appreciated, however, that features other than splines may be employed without departing from the scope of the present invention. The piston 80 is sealed to the inner surface 45 of the second portion 38 of the first member 14 by a seal 94 and is sealed to the third member 17 by a seal 96.

The biasing member 82 is concentric with the third member 17 and is located between the piston 80 and the third member 17. More specifically, the biasing member 82 is positioned to be circumferentially around the third member 17 and engages an inner detent 100 located on an inner surface of the piston 80 and engages the detent 78 on the third member 17. The detents 78, 100, an inner surface 102 of the piston 80, and an outer surface 104 of the third member 17 cooperate to form a space 106 where the biasing member 82 is located when the piston 80 is in either the first or second positions. In the embodiment provided, the biasing member 82 is a coil spring, however, various other biasing members may be employed without departing from the scope of the present invention. The biasing member 82 biases the piston 80 to the first position as shown in FIG. 1A.

The piston 80 is actuated or moved from the first position to the second position by a hydraulic fluid delivered from the actuation bore 32. When no hydraulic fluid is delivered from the actuation bore 32, the biasing member 82 positions the piston 80 to the first position, as shown in FIG. 1A. When in this position, the splined portion 88 engages the splined portion 44 of the first member 14 but does not engage the splined portion 62 of the second member 16.

During operation of the transmission 10, it may be desirable to directly couple the first member 14 with the second member 16 to provide a direct drive ratio. Accordingly, hydraulic fluid is delivered from the actuation bore 32 to the second portion 38 of the first member 14. The hydraulic fluid contacts the first end 84 of the piston 80 and moves or slides the piston 80 along the third member 17. As the piston 80 moves, the biasing member 82 is compressed within the space 106. The piston 80 ceases movement when the piston 80 reaches the second position, as shown in FIG. 1B. In the second position, the splined portion 88 engages the splined portion 44 of the first member 14 and also engages the splined portion 62 of the second member 16. Accordingly, the piston 80 rotatingly couples the first member 14 with the second member 16. During this shift of the splined clutch 18, the transmission 10 clutches and speed sensors are used to synchronize the speeds of the first member 14, second member 16, and piston 80 in order to allow engagement of the piston 80 and the second member 16 without interrupting the input torque from the engine. Alternatively, synchronization of the first member 14, sliding clutch 18, and the second member 16 may be accomplished by controlling the speed of the engine. Disengagement of the sliding clutch 18 preferably includes ceasing the flow of hydraulic fluid as well as controlling or interrupting the input torque from the engine in order to release torque on the splined portions 62 and 88 so that piston 80 may disengage from the second member 16.

The description of the invention is merely exemplary in nature and variations that do not depart from the gist of the invention are intended to be within the scope of the invention. Such variations are not to be regarded as a departure from the spirit and scope of the invention.

We claim the following:

1. An assembly for selectively coupling a first member to a second member in a transmission, the assembly comprising:
a shaft supported between the first member and the second member;
a sleeve shaft slidably disposed on the shaft and rotatably coupled to the first member, the sleeve shaft moveable between a first position and a second position, wherein the sleeve shaft rotatably engages only the first member when in the first position and the sleeve shaft rotatably engages the first member and the second member when in the second position; and
a biasing member disposed between the sleeve shaft and the shaft, the biasing member operable to bias the sleeve shaft into at least one of the first position and the second position.

2. The assembly of claim 1 wherein the sleeve shaft includes a feature located on an outer surface of the sleeve shaft and wherein the feature engages the second member to rotatingly couple the sleeve shaft to the second member when the sleeve shaft is in the second position.

3. The assembly of claim 2 wherein the feature engages the first member to rotatingly couple the first member to the sleeve shaft when the sleeve shaft is in the first position and the second position.

4. The assembly of claim 3 wherein the feature includes a plurality of splines.

5. The assembly of claim 1 wherein the shaft is coaxial with the first member and with the second member.

6. The assembly of claim 1 wherein the sleeve shaft is moved between from the first position to the second position by a hydraulic fluid.

7. The assembly of claim 6 wherein the sleeve shaft is sealed to the shaft and to the first member, and the hydraulic fluid actuates the sleeve shaft by engaging an end of the sleeve shaft between the first member and the sleeve shaft.

8. The assembly of claim 7 wherein the hydraulic fluid is communicated to the sleeve shaft via a fluid passage in the first member.

9. The assembly of claim 1 wherein the sleeve shaft includes an inner surface having an inner detent and the shaft includes an outer surface having an outer detent, wherein the biasing member is located between the inner surface of the sleeve shaft and the outer surface of the shaft and engages the inner detent and the outer detent in order to bias the sleeve shaft to the first position.

10. The assembly of claim 9 wherein the inner surface of the sleeve shaft and the outer surface of the shaft cooperate to define a pocket that houses the biasing member when the sleeve shaft is in the second position.

11. The assembly of claim 1 wherein the first member, second member, shaft, and sleeve shaft are coaxial.

12. An assembly in a transmission, the assembly comprising:
a first member having an open end with a coupling feature located on an inner surface of the open end;
a second member having an open end with a coupling feature located on an inner surface of the open end;
a third member supported between the first member and the second member;
a sleeve shaft slidably disposed on the third member and having a coupling feature on an outer surface of the sleeve shaft engaged with the coupling feature of the first member, the sleeve shaft moveable between a first position and a second position, wherein the coupling feature of the sleeve shaft engages the coupling feature of the second member and the coupling feature of the first member when the sleeve shaft is in the second position; and
a biasing member disposed between the sleeve shaft and the shaft, the biasing member operable to bias the sleeve shaft to at least one of the first position and the second position.

13. The assembly of claim 12 wherein the coupling features of the sleeve shaft, the first member, and the second member each include a plurality of splines.

14. The assembly of claim 12 wherein the first member, the second member, the third member, and the sleeve shaft are coaxial.

15. The assembly of claim 12 wherein the sleeve shaft is moved between from the first position to the second position by a hydraulic fluid.

16. The assembly of claim 15 wherein the sleeve shaft is sealed to the third member and to the first member, and the hydraulic fluid actuates the sleeve shaft by engaging an end of the sleeve shaft between the first member and the sleeve shaft.

17. The assembly of claim 16 wherein the hydraulic fluid is communicated to the sleeve shaft via a fluid passage in the first member.

18. The assembly of claim 12 wherein the sleeve shaft includes an inner surface having an inner detent and the third member includes an outer surface having an outer detent, wherein the biasing member is located between the inner surface of the sleeve shaft and the outer surface of the third member and engages the inner detent and the outer detent in order to bias the sleeve shaft to the first position.

19. The assembly of claim 18 wherein the inner surface of the sleeve shaft and the outer surface of the third member cooperate to define a pocket that houses the biasing member when the sleeve shaft is in the second position.
